(19) United States
(12) Patent Application Publication
(10) Pub. No.: US 2020/0240795 A1
(43) Pub. Date: Jul. 30, 2020

(54) ROAD MAP GENERATION SYSTEM AND ROAD MAP GENERATION METHOD

(71) Applicant: DENSO CORPORATION, Kariya-city (JP)

(72) Inventor: Toshio NOMURA, Kariya-city (JP)

(21) Appl. No.: 16/848,099

(22) Filed: Apr. 14, 2020

Related U.S. Application Data
(63) Continuation of application No. PCT/JP2018/037042, filed on Oct. 3, 2018.

(30) Foreign Application Priority Data
Dec. 15, 2017 (JP) 2017-240643

(51) Int. Cl. G01C 21/32; G01J 5/00; G06K 9/00

(52) U.S. Cl. CPC G01C 21/32; G01J 2005/0085; G06K 9/00798; G01J 5/00

(57) ABSTRACT

A road map generation system collects camera image data obtained by photographing a road on which each vehicle is traveling from a plurality of vehicles equipped with vehicular cameras, and generates the road map data based on the camera image data. The system includes a determination unit for determining a road surface state of the photographed road, and a lane center line calculation unit for determining a traveling center line of a vehicle travel lane of the road based on the road surface state.

### CROSS REFERENCE TO RELATED APPLICATION

The present application is a continuation application of International Patent Application No. PCT/JP2018/037042 filed on Oct. 3, 2018, which designated the U.S. and claims the benefit of priority from Japanese Patent Application No. 2017-240643 filed on Dec. 15, 2017. The entire disclosures of all of the above applications are incorporated herein by reference.

### TECHNICAL FIELD

The present disclosure relates to a road map generation system and a road map generation method for generating road map data based on camera image data.

### BACKGROUND

Conventionally, for example, a technique is known as a method for generating a digital road map used in a vehicular navigation device. In this road map generation method, the vehicle position data obtained over time from GPS when the vehicle is traveling is acquired as movement trajectory data, and a plurality of movement trajectory data is collected to create a database. The map data is generated based on calculation of a lane center line from these movement locus data using a statistical method. Moreover, when calculating the lane center line in a curve etc., the map is generated using a spline curve.

### SUMMARY

According to an example embodiments, camera image data obtained by photographing a road on which each vehicle is traveling is collected from a plurality of vehicles equipped with vehicular cameras, and the road map data is generated based on the camera image data. Further, a road surface state of the photographed road is determined; and a travel centerline of a vehicle travel lane on the photographed road is determined based on the road surface state.

### BRIEF DESCRIPTION OF THE DRAWINGS

The above and other objects, features and advantages of the present disclosure will become more apparent from the following detailed description made with reference to the accompanying drawings. In the drawings:

FIG. 1 shows a first embodiment, and schematically shows an overall configuration of the system;

FIG. 2 is a block diagram schematically showing the configuration of the vehicular device;

FIG. 3 is a block diagram schematically showing the configuration of the main part of the data center;

FIG. 4 is a flowchart schematically showing a map data generation process executed by the process control device;

FIG. 5 is a diagram showing an example of a camera image;

FIG. 6 is a plan view showing an example of a wheel track and a travelling center line in a vehicle travelling lane;

FIG. 7 is a diagram showing an example of a camera image according to the second embodiment;

FIG. 8 is a perspective view showing a mounting position of the temperature sensor according to the third embodiment;

FIG. 9 is a diagram showing an example of a camera image according to the fourth embodiment; and

FIG. 10 is a diagram showing a running condition of a lane on a snowy road.

### DETAILED DESCRIPTION

In recent years, there has been an increase in the realization of autonomous driving technology for vehicle, and there is a demand for developing high-accuracy road map data. However, since a conceivable technique utilizes a travel locus of a vehicle using the GPS, in some situations, a variation of a position may become large in a place where the GPS radio waves are difficult to receive, for example, in a tunnel or along a building street. Therefore, the actual situation is that the deviation from the actual position may become large and a sufficiently accurate road map may not be obtained. Also, since a spline curve is used when running in a curve, the conversion error may be large.

A road map generation system and a road map generation method are provided for generating a road map data based on collecting camera image data of a vehicular camera with a high precision of the road map data.

According to an aspect of the present embodiments, the road map generation system collects camera image data obtained by photographing a road on which each vehicle is traveling from a plurality of vehicles equipped with vehicular cameras, and generates the road map data based on the camera image data. The system includes a determination unit for determining a road surface state of the photographed road, and a lane center line calculation unit for determining a traveling center line of a vehicle travel lane of the road based on the road surface state.

According to this, when the camera image data obtained by capturing the road condition while the vehicle is traveling is collected from a plurality of vehicles, the road surface state of the captured road is determined by the determination unit. Then, the lane center line calculation unit obtains the travel center line of the vehicle travel lane on the road based on the road surface state. At this time, the travel center line of the vehicle travel lane on the road is obtained based on the road surface state on which the vehicle has actually traveled with respect to the camera image data obtained by photographing the road situation when the vehicle has actually traveled. As for the curve, the travel center line where the vehicle actually travels can be obtained.

Therefore, regardless of the reception status of GPS radio waves, it is possible to obtain data on the vehicle travelling lane and the travel center line, and it is possible to detect the travel center line with high precision. As a result, the road map data is generated based on the collection of the camera image data of the vehicular camera, and an excellent effect is achieved that it is possible to generate road map data with high precision. As a result, it can contribute to the development of high-accuracy road map data for autonomous driving.

The “travel center line” here corresponds to the trajectory of the center of the vehicle through which the most vehicles have passed (i.e., with the most frequent) in the vehicle that actually travels in the vehicle travel lane.

### First Embodiment

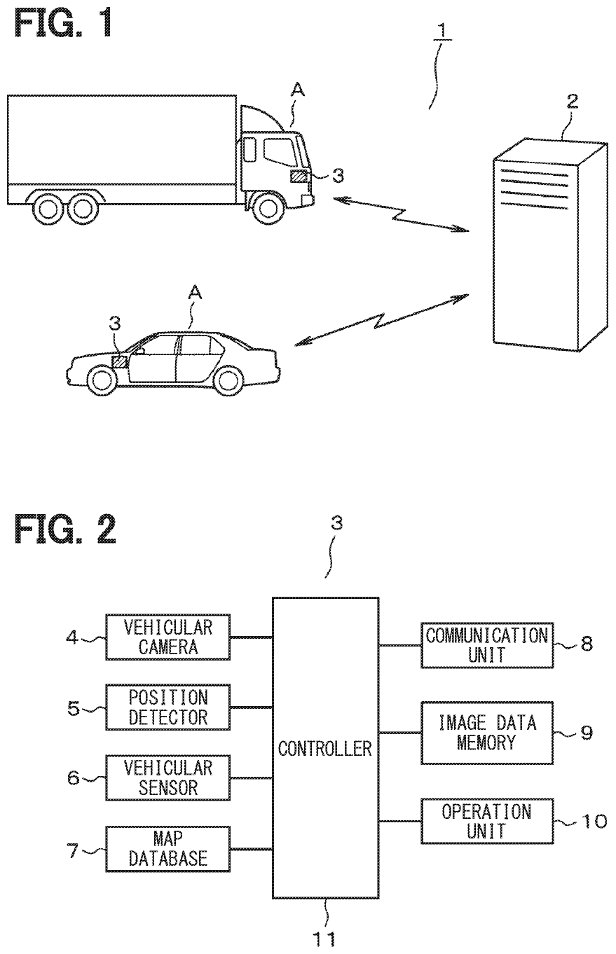

Hereinafter, a first embodiment describing the present disclosure will be described with reference to FIGS. 1 to 6. FIG. 1 schematically shows the overall configuration of a road map generation system 1 according to the present embodiment. Here, the road map generation system 1 includes a data center 2 that collects and analyzes camera image data and generates road map data, and a plurality of vehicles A that travel on the road. Specifically, the vehicles A include the entire general automobile such as a passenger car and a truck.

Each vehicle A is equipped with an vehicular device 3 for realizing the road map generation system 1. As shown in FIG. 2, the vehicular device 3 includes a vehicular camera 4, a position detection unit 5, various vehicular sensors 6, a map database 7, a communication unit 8, an image data storage unit 9, an operation unit 10, and a control unit 11. The vehicular camera 4 is configured, for example, to be disposed in the front part of the vehicle A and is configured to photograph at least a road situation ahead of the traveling direction. The position detection unit 5 detects the vehicle position based on reception data of a GPS receiver. The various vehicular sensors 6 detect speed information of the subject vehicle, information on the traveling direction (or the orientation), and the like. The vehicular camera 4 may be arranged on a front side and a rear side and/or on a right side and a left side of the vehicle. Moreover, as a type of the vehicular camera 4, a wide-angle camera may be adopted, and it is preferable to arrange a camera with two or more lens especially for the front camera.

The map database 7 stores, for example, nationwide road map information. The communication unit 8 performs communication with the data center 2 via a mobile communication network or using road-to-vehicle communication. The image data memory 9 stores camera image data captured by the vehicular camera 4 with attaching data such as the vehicle position, the traveling speed, the traveling direction, and the photographing date at that time. The operation unit 10 includes a switch and a display unit (not shown), and a user (i.e., a driver) of the vehicle A performs necessary operations.

The control unit 11 includes a computer, and controls a whole of the vehicular device 3. In this case, while the vehicle A is traveling, the control unit 11 always captures the road situation ahead of the vehicle by the vehicular camera 4, and stores the camera image data in the image data memory 9 together with the vehicle position data and the like. The control unit 11 controls the communication unit 8 to transmit the camera image data stored in the image data memory 9 to the data center 2 periodically, for example, once a day.

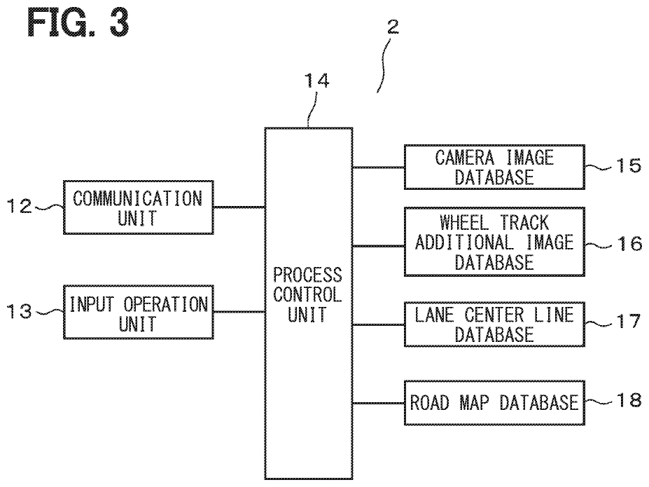

On the other hand, as shown in FIG. 3, the data center 2 includes a communication unit 12, an input operation unit 13, a process control unit 14, a camera image database 15, a wheel track additional image database 16, a lane center line database 17, and a road map database 18. The communication unit 12 receives the camera image data through communication with the communication unit 8 of each vehicle A. The input operation unit 13 is for an operator to perform a necessary input operation.

The process control unit 14 mainly includes a computer and controls the entire data center 2. Along with this, as will be described in detail later, the process control unit 14 executes a process such as a road map data generation process. In the camera image database 15, the camera image data transmitted from each vehicle A is collected and stored. At this time, for example, a large amount of camera image data is collected from general vehicles A traveling all over Japan.

In addition, in the road map data generation process executed by the process control unit 14, the image data to which the wheel track data is added is stored in the wheel track additional image database 16. The lane center line database 17 stores data on the obtained travelling center line of the lane. Further, the road map database 18 stores the generated high-accuracy road map data.

As will be described later in the description of the operation (i.e., in the flowchart description), in the present embodiment, the process control unit 14 of the data center 2 executes the following process when performing the road map data generation process. That is, first, the process control unit 14 performs image processing on the camera image data stored in the camera image database 15 to extract the vehicle traveling lane on the road, and executes a process (i.e., a determining process) for determining the road surface state of the road. And the process control unit 14 performs a process (i.e., a lane centerline calculation process) of the lane centerline calculation for calculating the driving centerline of the vehicle driving lane of the road based on the road surface condition determined in the determination process.

At this time, in the present embodiment, the process control device 14 detects, in the determination process, a trace of the vehicle (particularly, a four-wheeled vehicle) traveling from the camera image data as the road surface state. More specifically, a wheel track on which the wheels of the vehicle have passed is detected as a trace of the vehicle traveling. In the lane centerline calculation process, the travelling centerline of the vehicle travelling lane is obtained by connecting the center positions of the widths in the left and right direction from the detected wheel tracks, i.e., the traces of the vehicle travelling in this case. Here, in this embodiment, when there are multiple traces of a plurality of types of vehicles travelling which have different tread widths, the average center of these traces is obtained and used as the travel center line of the vehicle travel lane. In addition, motorcycles and other two wheel vehicles are excluded from detection.

As a result, the latest high-precision road map data is generated based on the obtained travel center line of the vehicle travel lane and stored in the road map database 18. Although not shown, in the road map generation system 1 of the present embodiment, the data center 2 is configured to provide the latest generated road map data and the like to the external devices. For example, the traffic information is provided from the data center 2 to the dynamic information center, or the high-precision road map data for autonomous driving operations is provided to a map supplier, a car maker, or the like.

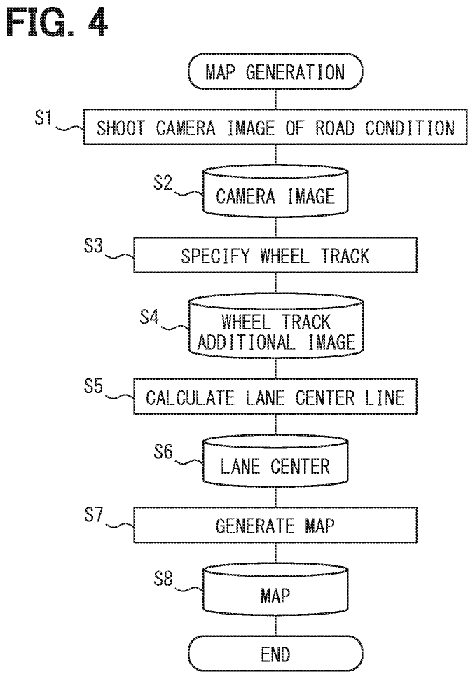

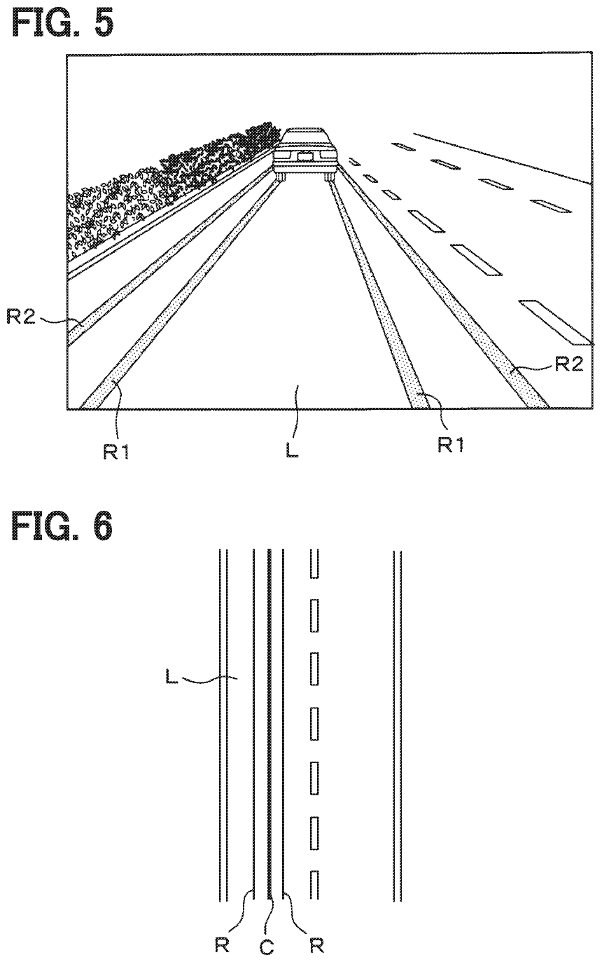

Next, the operation of the road map generation system 1 configured as described above will be described with reference to FIGS. 4 to 6. The flowchart of FIG. 4 shows the procedure of the road map data generation process that is mainly executed by the process control device 14 of the data center 2. That is, in FIG. 4, first, in step S1, the vehicular device 3 of each vehicle A captures a road condition during traveling by the vehicular camera 4. In the next step S2, the camera image data taken by each vehicle A is collected in the data center 2 and uploaded in the camera image database 15. An example of the camera image at this time is shown in FIG. 5.

In this case, the process of step S1 is executed by the control of the controller 10 in each vehicle A. In the process of step S2, the camera image data is transmitted from each vehicle A to the data center 2 via the communication unit 8. At the data center 2, the camera image data received via the communication unit 12 is uploaded in the camera image database 15 under the control of the process control unit 14. In this case, the latest camera image data of roads across the nationwide is collected from a large number of general vehicles A traveling on the roads throughout the country.

Steps S3 to S6 are image processing steps executed by the process control unit 14. In step S3, a camera image is read out from the camera image database 15, and a process of extracting (i.e., specifying) the road (i.e., the travelling lane) and the position of the wheel track on the road is performed from each frame image. Here, when the road surface of the road has concavities and convexities, the state of light reflection differs depending on the concavities and convexities, so that the color (or brightness) in the camera image of the wheel track may be different from the other parts. Thereby, it becomes possible to extract and identify the wheel track.

At this time, as illustrated in FIGS. 5 and 6, the vehicle travel lane L is specified by the white line marking (such as a boundary line, a center line, etc.) on the road, and a pair of left and right wheel tracks R are detected in the vehicle travel lane L (See FIG. 6). Here, the width dimension (or a tread width) between the left and right wheels differs depending on the type of vehicle such as a large-sized vehicle or a small-sized vehicle. Therefore, as shown in FIG. 5, in some cases, a wheel track R1 of a small-sized car such as a standard-sized car and a wheel track R2 of a large-sized car such as a truck may be disposed in one vehicle travel lane L, and these two kinds of tracks R1 and R2 may be specified. When the positions of wheel tracks R (or R1 and R2) are specified in this way, the position data of the specified wheel tracks R (or R1 and R2) is written in the wheel track additional image database 16 in step S4.

In the next step S5, the position data of the wheel track R is read out from the wheel track additional image database 16, and as shown in FIG. 6, the process of calculating the traveling center line C in which the vehicle A has actually traveled in the vehicle traveling lane L is performed. In this case, as described above, when a plurality of types of wheel tracks R1 and R2 are disposed, the travelling center line C is obtained by calculating the average of the centers obtained from the wheel tracks R1 and R2. In step S6, the obtained position data of the travel center line C of each vehicle travel lane L is stored in the lane center line database 17.

Thereafter, in step S7, the road map data is generated based on the obtained travel center line C and the like, and is stored in the road map database 18 in step S8. Through the above process, the latest and highly accurate road map data is generated. In this case, when the road map data is adopted as data for autonomous driving operations, the vehicle travels along the traveling center line C on a road including a curve or the like. Although a detailed description of the method for generating the road map data is omitted, for example, the camera image data is processed, and a frame image is converted into an orthographic image from directly above. Thereafter, a well-known method may be employed, such as a method for generating the road map data based on generation of a combined image by combining and arranging a plurality of orthographic images along the road.

As described above, according to the road map generation system 1 of the present embodiment, the following excellent effects are obtained. That is, in the present embodiment, the travel center line C of the vehicle traveling lane L of the road is obtained based on the road surface state on which the vehicle A has actually traveled, with respect to the camera image data obtained by photographing the road situation when the vehicle A has actually traveled. As for the curve, the travel center line C where the vehicle has actually traveled may be obtained. Therefore, according to the present embodiment, different from a case where a vehicle travel locus based on the GPS data is used data on the vehicle travel lane L and the travel center line C are obtained without depending on the GPS radio wave reception status. Thus, the traveling center line C is detected with high accuracy.

As a result, the road map data is generated based on the collection of the camera image data of the vehicular camera 4, and it is possible to generate the road map data with high precision. As a result, it can contribute to the development of high-accuracy road map data for autonomous driving. Further, in the road map generation system 1 of the present embodiment, the map data is generated based on collecting camera image data from the vehicular cameras 4 of a general large number of vehicles A traveling on roads nationwide. As a result, it is possible to obtain an advantage that high-precision map data is generated at low cost, different from a case where data is obtained by running a dedicated vehicle.

At this time, in the present embodiment, in the determination process, a trace of the vehicle A traveling as the road surface state of the road is detected from the camera image data, and in the lane center line calculation process, the travel center line C of the vehicle travel lane L is determined from the travel trace. Thereby, the traveling locus of the vehicle C is reliably determined from the camera image data. And the travelling centerline C of the vehicle travelling lane L is calculated reliably. In particular, in the present embodiment, the configuration is such that the wheel track R through which the wheels of the vehicle has passed is detected as the trace of the vehicle A traveling, so that the detection is relatively easy and the traveling locus of the vehicle A is detected easily and reliably.

Furthermore, in the present embodiment, when the traces (i.e., the wheel tracks R1 and R2) exists such that a plurality of types of vehicles A having different tread widths have traveled, the average center is obtained in the lane centerline calculation process and the traveling center line C of the vehicle travel lane L is determined. This makes it possible to obtain an effective travel center line C that is not biased toward any of different types of vehicles A such as small cars and large cars.

### (2) Second Embodiment to Fourth Embodiment and Other Embodiments

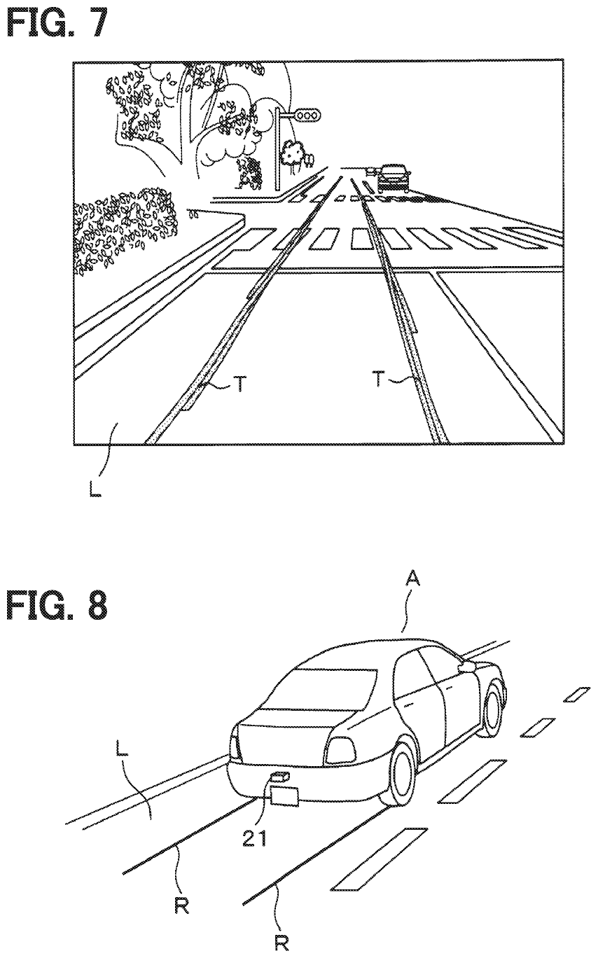

Next, the second to fourth embodiments will be described in order with reference to FIGS. 7 to 10. In the second to fourth embodiments described below, the same parts as those in the first embodiment are denoted by the same reference numerals, and repeated illustrations and repeated descriptions are omitted.

FIG. 7 shows a second embodiment, which differs from the first embodiment in the following points. That is, in the determination process, the process control device 14 detects a tire mark T attached on the road surface as a trace of the vehicle A traveling from the camera image. In this case, since the color of the road surface of the tire mark T becomes black, the tire mark T can be extracted and specified based on the feature that the color thereof is different from other parts. Also by this, similar to the first embodiment, it is possible to detect the tire mark T attached on the road surface from the camera image data relatively easily, and the traveling locus of the vehicle A equivalent to the wheel track R is detected easily and reliably. As a result, similar to the first embodiment, it is possible to generate highly accurate road map data.

FIG. 8 shows a third embodiment, which differs from the first embodiment in the following points. That is, the vehicle A is provided with a temperature sensor 21 that detects a road surface temperature distribution on a road (i.e., the traveling lane L) that the vehicle is traveling (i.e., that is photographed by the vehicular camera 4). The temperature sensor 21 includes, for example, an infrared radiation type temperature sensor (i.e., a thermography), and detects a temperature distribution in a direction orthogonal to the traveling direction of the vehicle A on the road surface, that is, a road width direction, and obtains a heat distribution image. The detected heat distribution image is transmitted to the data center 2 together with the camera image data.

And the process control unit 14 of the data center 2 detects the trace which the vehicle A travels, based on road surface temperature distribution. In this case, on the road on which the vehicle A travels, the temperature of the road surface rises only on that portion due to the friction between the road surface and the wheels (i.e., tires). Therefore, even when the wheel track R of the road surface or the tire mark T is difficult to detect on the image, the temperature sensor 21 detects the road surface temperature distribution of the road being photographed, so that the travelling trajectory of the vehicle A equivalent to the wheel track R can be detected. As a result, similar to the first embodiment, it is possible to generate highly accurate road map data.

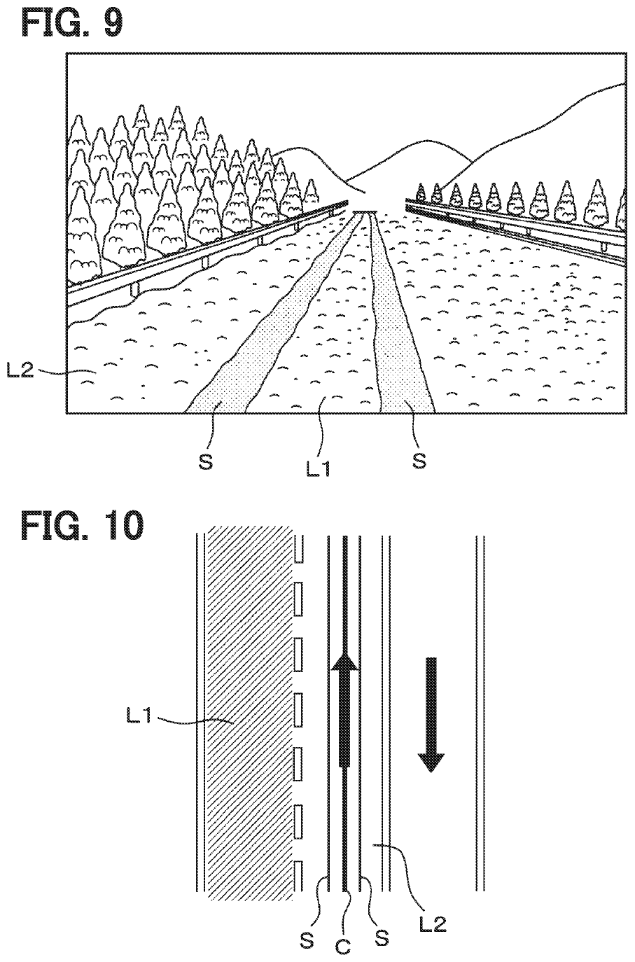

FIGS. 9 and 10 show a fourth embodiment, which differs from the first embodiment and the like in the following points. That is, in the determination process, the process control unit 14 specifies a running trace (i.e., a snow melting trace) S on a snowy road as a trace of the travelling vehicle A from the camera image. Here, this running trace S corresponds to the wheel track R. Also in this manner, as in the first embodiment, it is possible to relatively easily detect the travel trace S on the snow road attached to the road surface from the camera image data, and to easily and reliably detect the travel trajectory of the vehicle A. Thus, it can generate the highly accurate road map data.

At the same time, in the present embodiment, the process control unit 14 executes, with respect to a road having a plurality of vehicle lanes on one side, a process (i.e., a frequency information acquisition process) for acquiring frequency information that the vehicle travels in each vehicle lane in each section of the road. Furthermore, a process (i.e., a recommended lane information process) for generating recommended lane traveling information based on the frequency information is executed. As a specific example, as shown in FIG. 10, for example, on a road having two lanes of vehicle travel lanes L1 and L2 on one side, it is possible for the vehicle to travel on either of the vehicle lanes L1 and L2. Here, no vehicle travels on the left vehicle travel lane L1, and snow has been piled up and the travel trace S does not exist. On the other hand, the frequency of the vehicle A travelling on the right vehicle travel lane L2 is high, and the lane L2 has a clear travel trace S. That is, the frequencies with which the vehicle A travels in the vehicle travel lanes L1 and L2 is biased to one side.

In such a case, it may be said that it is easier to travel on the snowy road on the vehicle travel lane L2 with the travel trace S. The vehicle travel lane L1 in which no vehicle has traveled is difficult to travel for the vehicle. Accordingly, the process control device 14 generates the information for recommending the lane selection based on the information on the frequency with which the vehicle A travels in each of the vehicle travel lanes L1, L2, that is, the information which vehicle travel lane L1, L2 should be traveled. Thereby, not only the road map data is generated but also effective information such as recommended lane information can be added thereto.

In each of the above-described embodiments, various processes (or steps) in the data center 2 are automatically performed by the process control unit 14 including a computer. Alternatively, the processes may be performed semi-automatically, for example, according to an input instruction of an operator. According to this, for example, when specifying a running trace of a car on a snowy road, a tire trace, or a wheel track as a travelling trajectory of a vehicle, the camera image data may be displayed on the display device, and the operator may specify a position of the travel trace on the displayed camera image. Thereby, it is possible to easily extract and specify the running trace from the actual image.

In the fourth embodiment, the recommended lane-selection information regarding the snowy road is generated. Alternatively, the lane-selection information may be generated based on the frequency information not only for the snowy road but also for all roads with a plurality of lanes. Further, in each of the above embodiments, the camera image data is collected from the vehicle A by wireless communication. Alternatively, for example, the camera image data may be collected via a storage medium such as an SD card. In addition, various changes may be made to the hardware configuration of the vehicle the vehicular device) and the data center.

Although the present disclosure is described based on the above embodiment, the present disclosure is not limited to the embodiment and the structure. The present disclosure encompasses various modifications and variations within the scope of equivalents. In addition, various combinations and forms, and further, other combinations and forms including only one element, or more or less than these elements are also within the scope and the scope of the present disclosure.

What is claimed is:

1. A road map generation system that collects camera image data, obtained by photographing a road on which a plurality of vehicles travel, from the plurality of vehicles equipped with vehicular cameras, and generates road map data based on the camera image data, the system comprising:
a determination device that is configured to determine a road surface state of a photographed road; and
a lane centerline calculator that is configured to determine a travel centerline of a vehicle travel lane on the photographed road based on the road surface state.

2. The road map generation system according to claim 1, wherein;
the determination device detects a travel trajectory of each vehicle as the road surface state of the photographed road from the camera image data; and
the lane centerline calculator determines the travel centerline of the vehicle travel lane from the travel trajectory.

3. The road map generation system according to claim 2, wherein:
the determination device detects, as the travel trajectory of each vehicle, at least one of a wheel track on which a wheel has passed, a tire mark attached to a road surface, and a travel trace on a snowy road.

4. The road map generation system according to claim 1, wherein:
the vehicle includes a temperature detector for detecting a road surface temperature distribution of the photographed road; and
the determination device detects the travel trajectory of each vehicle based on the road surface temperature distribution.

5. The road map generation system according to claim 1, wherein:
the lane centerline calculator determines an average centerline of a plurality of travel trajectories as the travel centerline of the vehicle travel lane when the plurality of travel trajectories, on which a plurality of types of vehicles having different tread widths travel, are disposed on the photographed road.

6. The road map generation system according to claim 1, further comprising:
a frequency information acquisition device that is configured to acquire frequency information for a vehicle traveling in each vehicle travel lane in each section of the photographed road when the photographed road has a plurality of vehicle travel lanes on one side; and
a recommendation lane information generation device that is configured to generate recommendation lane selection information based on the frequency information.

7. A road map generation method that collects camera image data, obtained by photographing a road on which a plurality of vehicles travel, from the plurality of vehicles equipped with vehicular cameras, and generates road map data based on the camera image data, the method comprising:
determining a road surface state of the photographed road; and
determining a travel centerline of a vehicle travel lane on the photographed road based on the road surface state.

8. The road map generation method according to claim 7, wherein:
the determining of the road surface state includes detecting a travel trajectory of each vehicle as the road surface state of the photographed road from the camera image data; and
the determining of the travel centerline includes determining the travel centerline of the vehicle travel lane based on the travel trajectory.

9. The road map generation method according to claim 8, wherein:
the determining of the road surface state includes detecting, as the travel trajectory of each vehicle, at least one of a wheel track on which a wheel has passed, a tire mark attached to a road surface, and a travel trace on a snowy road.

10. The road map generation method according to claim 7, wherein:
the vehicle includes a temperature detector for detecting a road surface temperature distribution of the photographed road; and
the determining of the road surface state includes detecting the travel trajectory of each vehicle based on the road surface temperature distribution.

11. The road map generation method according to claim 7, wherein:
the determining of the travel centerline includes determining an average centerline of a plurality of travel trajectories as the travel centerline of the vehicle travel lane when the plurality of travel trajectories, on which a plurality of types of vehicles having different tread widths travel, are disposed on the photographed road.

12. The road map generation method according to claim 7, further comprising:
acquiring frequency information for a vehicle traveling in each vehicle travel lane in each section of the photographed road when the photographed road has a plurality of vehicle travel lanes on one side; and
generating recommendation lane selection information based on the frequency information.

13. A road map generation system that collects camera image data, obtained by photographing a road on which a plurality of vehicles travel, from the plurality of vehicles equipped with vehicular cameras, and generates road map data based on the camera image data, the system comprising:
a processor which is configured to: determine a road surface state of a photographed road; and to determine a travel centerline of a vehicle travel lane on the photographed road based on the road surface state.
